(19) United States
(12) Patent Application Publication
(10) Pub. No.: US 2004/0139918 A1
(43) Pub. Date: Jul. 22, 2004

(54) Cricket habitat and retail receptacle

(76) Inventor: Gordon J. Vadis, Ham Lake, MN (US)

Correspondence Address: GRAY, PLANT, MOOTY, MOOTY & BENNETT, P.A., P.O. BOX 2906, MINNEAPOLIS, MN, 55402-0906, US

(21) Appl. No.: 10/754,290

(22) Filed: Jan. 9, 2004

Related U.S. Application Data
(60) Provisional application No. 60/440,264, filed on Jan. 14, 2003.

(51) Int. Cl. A01K 29/00

(52) U.S. Cl. 119/6.5

(57) ABSTRACT

A live insect habitat that also serves as a retail receptacle for point of sale display of the insects. In particular, the invention comprises a cricket habitat and point of sale display receptacle for the sale of live crickets primarily for fishing bait and pet food purposes. The habitat/receptacle includes a housing having side walls with a sight window formed therein for purposes of permitting viewing of the inside of the housing and insect habitat from the outside. A habitat insert is located inside the housing and includes a two sided member having a convoluted surface giving the crickets ample area upon which to crawl about. The housing and the habitat insert can be made of a moisture absorbent material in order to reduce the moisture content of the cricket environment. An item of cricket food is located in the housing whereby the retail habitat/receptacle has a prolonged shelf life while maintaining healthy live crickets.

### CROSS REFERENCE TO RELATED APPLICATION

This application claims the benefit of U.S. Provisional Patent Application Serial No. 60/440,264 filed Jan. 14, 2003.

### BACKGROUND OF THE INVENTION

Live crickets are used as bait for fishing and for pet food. There is a substantial market for live crickets. At retail crickets are typically sold in bulk. Quantities of crickets are scooped or otherwise derived from a bulk container such as an aquarium and given to the customer in a bag or like receptacle. The crickets do not thrive well in the bulk container environment unless tended to with food and water on a periodic basis. Many do not survive. Those that do may not be particularly healthy if they have been neglected. The bulk container can create odor problems at the retail establishment. Many crickets escape and run loose about the establishment or craw into a neighboring establishment. Inventory control is a problem because it is difficult to accurately control numbers dispensed from bulk containers and because of cricket die-off. Dispensing crickets from a bulk container is labor intensive for the retailer and inconvenient for both the employee and consumer.

Crickets are sold in bulk at mail order in cardboard boxes that do provide a crowded and not particularly healthy environment.

### SUMMARY OF THE INVENTION

The invention pertains to an insect habitat and retail receptacle for the purpose on the one hand of providing a healthy environment habitat for a number of live insects such as crickets and at the same time providing a retail point-of-sale package for selling the crickets. The habitat/retail package includes a cardboard box or housing with a window opening covered by a suitable transparent material such as clear plastic. A habitat insert is located in the box. The insert is comprised of a convoluted egg carton-like structure having ridges or peaks and valleys that extend substantially from surface to surface of the box interior. The insert fits loosely at the ends of the box to permit spaces for the crickets to crawl around from one surface of the habitat insert to another. The insert provides dark regions and regions of subdued light which are favored by crickets. The insert can be of a moisture absorbent material. The insert can be a soft cardboard type material which is favored by crickets for chewing. Nourishment in the form of a supply of food and water is placed inside the box. Alternatively, a high moisture content food item such as a piece of carrot or commercially available cricket food is placed inside of the box.

The cricket habitat/package has a shelf life of a matter of weeks. The crickets are healthy and well fed, resulting in a “gut-loaded” cricket which is more nutritious to the pet being fed. The prepackage does away with the bulk inventory of crickets. The prepackaged cricket habitats can be sold from a dispenser on a self-serve basis by which boxes are loaded into the dispenser from the top and dispensed from the bottom. This results in rotation of the stock. This also eliminates the need for an employee diversion to dispense crickets from a bulk container.

The cardboard box can be made difficult to open so as to be tamper proof. The crickets, however, are clearly visible through the window of the box.

The habitat insert in the box provides a climbing and nesting habitat for the crickets. It also provides areas and spaces for the more vulnerable crickets to hide from the others. The cardboard of the insert and of the box absorbs and disperses condensation as may develop during shipping or as may be generated by a food and water supplement in the box. This is desirable as crickets do not like to be wet. The box and the insert provide dark areas for the crickets to escape from the light and from one another.

The convolutions of the habitat insert maximize surface area inside the box available for crickets to climb. The insert helps keep the box from being crushed, lending support from top to bottom, side to side and end to end.

According to another form of the invention a cricket habitat/retail package has a cylindrical housing. A convoluted habitat insert is located in the housing. An end cover to the housing has a window for viewing the interior of the housing.

In the Drawings:

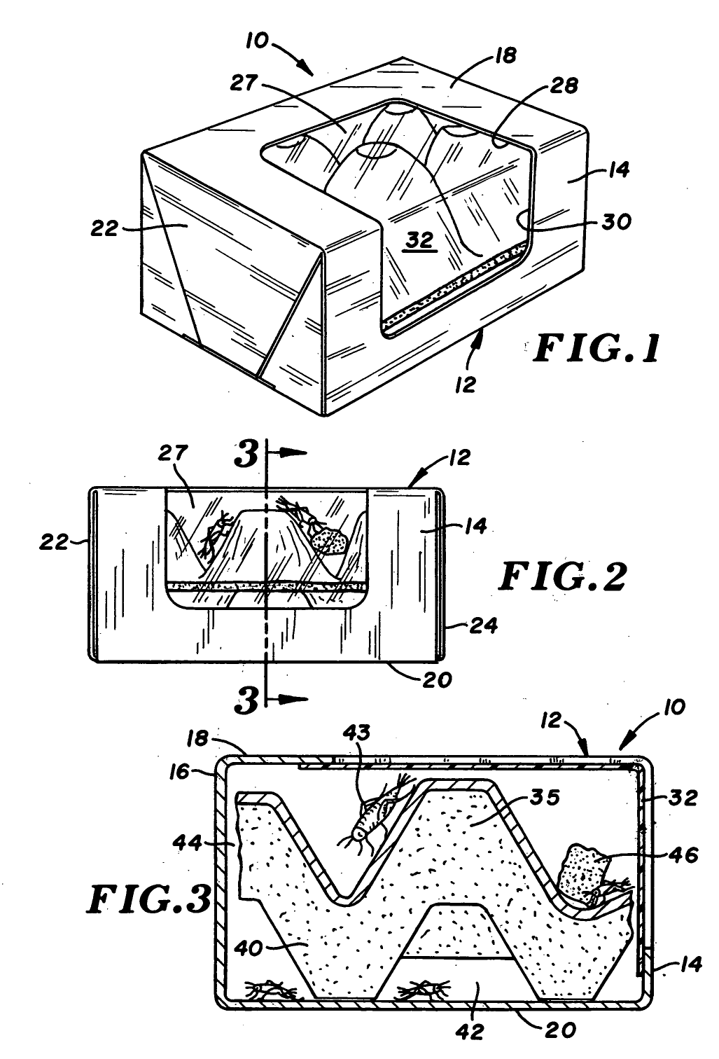

FIG. 1 is perspective view of a cricket habitat/retail package according to one form of the invention;

FIG. 2 is a front view of the cricket habitat/retail package of FIG. 1;

FIG. 3 is a sectional view of the cricket habitat/retail package of FIG. 2 taken along the line 3-3 thereof;

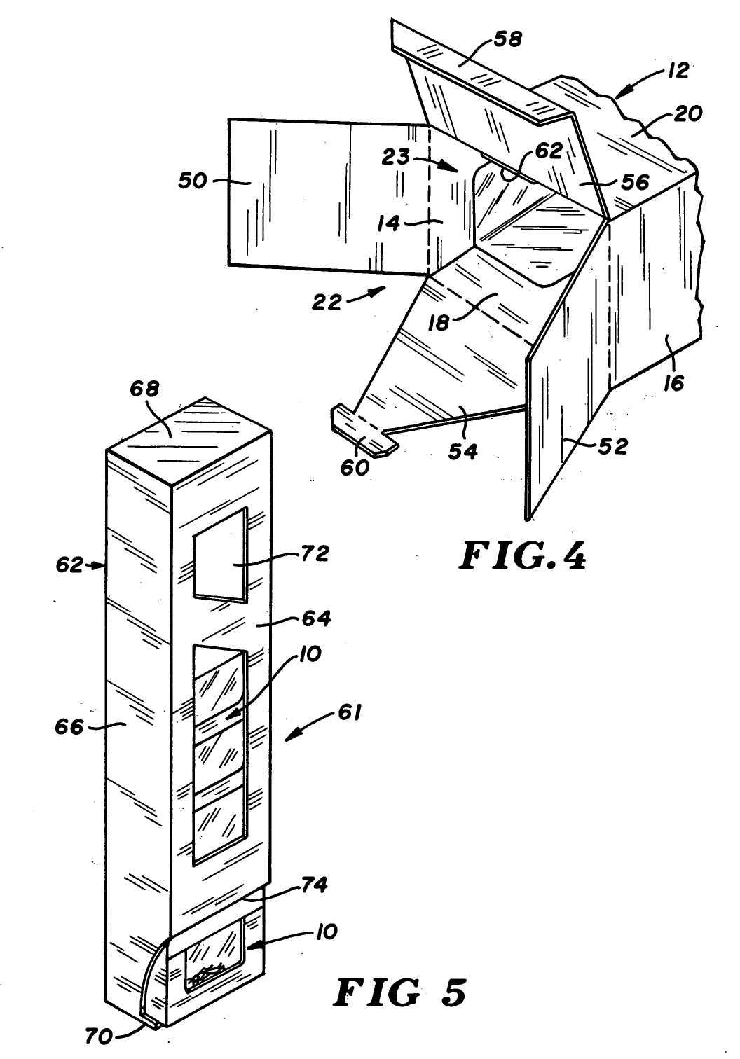

FIG. 4 is a view of the end of the box of the cricket habitat of FIG. 1 in an open configuration to show the closure system thereof;

FIG. 5 is a front perspective view of a dispenser holding a number of cricket habitat/retail packages of FIG. 1 displayed for retail sale;

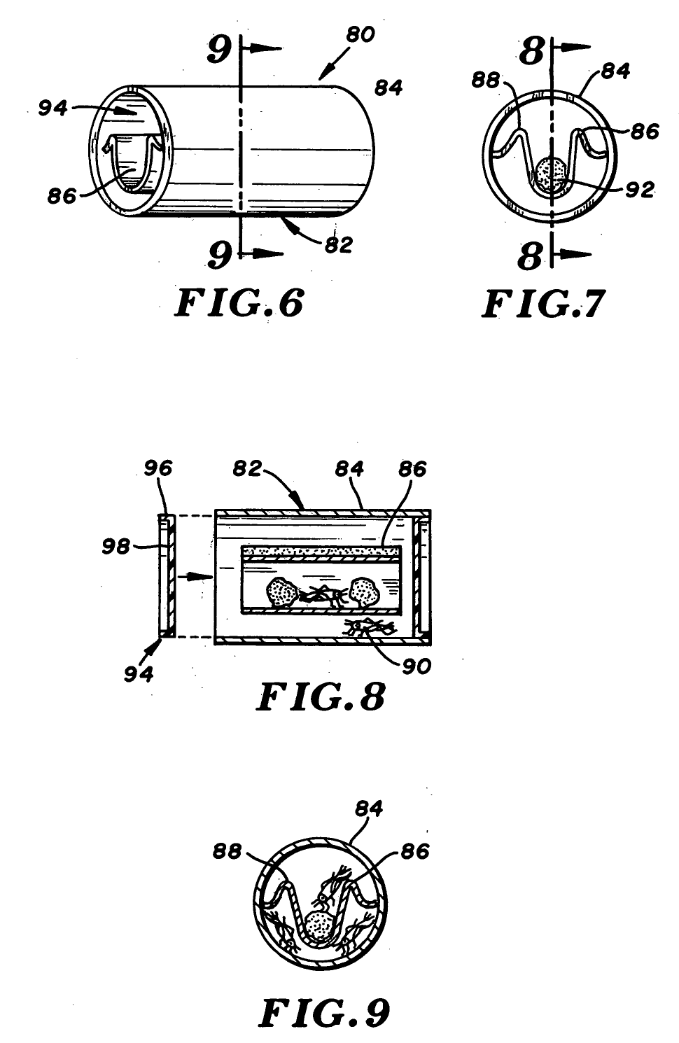

FIG. 6 is a side view in perspective of a cricket habitat/retail package according to a second form of the invention;

FIG. 7 is an end view of the cricket habitat/retail package of FIG. 6;

FIG. 8 is a sectional view of the cricket habitat/retail package of FIG. 7 taken along the line 8-8 thereof showing a cover removed; and

FIG. 9 is a sectional view of the cricket habitat/retail package of FIG. 6 taken along the line 9-9 thereof.

### DESCRIPTION OF PREFERRED EMBODIMENTS

Referring to FIGS. 1 through 4, there is shown an insect habitat and retail package indicated generally at 10. As described herein habitat 10 houses crickets although habitat 10 could house other species of insect as well. Habitat 10 includes a housing 12 formed of a rectangular box of cardboard or of a material having similar properties. Housing 12 has an interior space or room for habitation by crickets. Housing 12 has a front wall 14, a back wall 16, a top wall 18 and a bottom wall 20 which define the interior habitat space for insects. The ends of box housing 12 are closed by end closures 22, 24 as will be more fully described. The box can be 1″ to 3″ high, 3″ to 5″ wide and 2″ to 4″ deep. By way of example, the box can typically be 3″×4″×2″ and house 25 to 50 crickets.

Housing 12 has a sight window 27 for viewing crickets. Sight window is a corner window. The sight window 27 is comprised of a first cutout 28 opening in the top wall 18 and an adjoining second cutout opening 30 in the front wall 14. A continuous clear transparent paper or plastic material 30 covers the cutout openings and traverses the corner formed at top wall 18 and front wall 14. The sight window 27 enables viewing of a portion of the interior of the housing 12 from the outside. The sight window can by way of example be 2″ to 4″ wide and have a dimension of 1″ to 2″ on the front wall of the housing, and 1½″ to 2½″ on the top wall.

A live cricket habitat environment is provided by a habitat insert 34 located inside the housing 12. Insert 34 substantially fills housing 12 from side to side and top to bottom. Insert 34 is a two-sided, convoluted surface structure. Insert 34 can have a surface roughness 35. In one embodiment insert 34 is comprised as an egg carton type structure. Habitat insert 34 has top and bottom surfaces characterized by peaks or ridges 36 separated by valleys 38. The convolutions form legs 40 spaced apart by tunnels 42 (FIG. 3). Insert 34 can be formed of a soft cardboard like material. Insert 34 provides an ideal environment for crickets. It is loosely disposed inside the housing 12 providing access spaces such as the space 44 (FIG. 3) for crickets 43 to move from one surface area to another. The insert provides a number of separate rooms and a large surface area for the crickets 43 to crawl about. Crickets are known to be omnivorous whereby more dominant crickets will eat more vulnerable ones. The various surfaces of habitat insert 34 and the spaces 44 permit the more vulnerable crickets to escape to other areas. While a measure of light is permitted through the transparent window 32, the various ridges and valleys of insert 34 still provide a large amount of darkened volume. The various ridges, valleys, legs and tunnels of insert 34 provide dark areas for live crickets 43 as well as areas of subdued light, both of which are preferred by crickets. The soft cardboard of the insert 34 as well as the soft cardboard of the housing 12 can be chewed by crickets.

Food and water are provided in the housing 12. These can take the form of a high moisture food item such as a piece of carrot or such as the cricket food item indicated at 46 in FIG. 3. Crickets with such a food supply can survive for a period of at least seven days. The food supply can be periodically replenished. This prolongs the shelf-life of the product.

Crickets do not like moisture. The soft cardboard of the insert 34 is moisture absorbent to absorb condensation that may develop in the package during shipping or otherwise. The box “breathes” and wicks moisture to the outside where it evaporates. The insert 34 provides a measure of rigidity to the housing 12 by spanning the interior volume thereof. This is useful in terms of shipping the item and inventorying the item in a store.

It is desirable to eliminate pin-point light spots in housing 12 of the type that may occur at closure corners. Crickets are attracted to such light spots and tend to chew there and then escape through the chewed opening. The end closures of housing 12 address this problem.

As shown in FIG. 4, end closure 22 closes an end opening 23 to housing 12. Closure 22 includes opposing end flaps 50, 52 that are pivotally attached to the edges of front and back walls 14, 16 adjacent end opening 23 and are positioned to fold over the end opening 23. Each of the end flaps 50, 52 has a sufficient length and width to cover the end opening 23 when folded over it.

Top and bottom flaps 54, 56 are connected to the edges of the top and bottom walls 18, 20 of housing 12 adjacent the end opening 23 and are foldable over the end flaps. Bottom flap 56 has a length and width to substantially cover the end opening 23 when folded over the end flaps 50, 52. Bottom flap 56 has an outer lip 58 that is inserted between the edges of the end flaps in the closed position and the adjacent part of top wall 18.

Top flap 54 has tapered edges ending in a head 60 and is adapted to be folded over the end flaps 50, 52 and bottom flap 56. A slot 62 is located at the intersection of the bottom flap 56 and the bottom wall 20. When the top flap 54 is folded over the end opening 23, the head 60 can be inserted into the slot 62 in order to secure closure 22 in the closed position. When in such closed position, light leakage is substantially eliminated.

FIG. 5 shows a dispenser indicated generally at 61 for the cricket habitat/retail package of FIG. 1. The dispenser 61 includes a long, upright dispenser carton 62 having a rectangular cross-section with interior dimensions sufficient to accommodate the cricket habitat/retail packages 10. Dispenser carton 62 has a front wall 64, side walls 66 connected to a back wall (not shown). A hinged lid 68 closes the top opening formed at the top of the front, side and back walls. Opening the hinged lid 68 permits loading the dispenser carton 62 with packages 10 to be displayed for resale. A bottom wall 70 supports packages 10 held in the dispenser.

Front wall 64 has sight slots 72 for viewing packages 10 stored in the dispenser 61. A dispensing opening 74 is located at the lower end of front wall 64. Dispensing opening 74 is large enough to permit packages 10 to be withdrawn or dispensed one at a time from the dispenser housing 62. As a package is removed from the dispensing opening 74 the next package drops down to the position of the previously withdrawn one. There is a continual rotation of stock. The carton 62 can be hung on a wall and used as a self-service display. The carton covers the corners of the boxes which might otherwise permit light seepage. Darkened corners provide no incentive for crickets to chew isolated points. This reduces the likelihood of escape by way of chewing out of the box.

FIGS. 6 through 9 show a further embodiment of a cricket habitat/retail package according to the invention indicated generally at 80. Cricket habitat 80 includes a cylindrical box or housing 82 formed of cardboard or a material having properties similar to cardboard. Housing 82 is moisture absorbent and has opaque cylindrical sidewalls 84. A habitat insert 86 is located inside housing 82. Habitat insert 86 is a convoluted sheet material extending from side-to-side across the interior of housing 82. Insert 86 has convolutions 88 providing a large surface area on which the live crickets 90 can crawl about. The ends of insert 86 are spaced from the ends of housing 80 permitting crickets 90 to crawl from one surface of the habitat insert 86 to the other. A food item 92 is lodged in a convolution of the habitat insert 86. Sidewalls 84 and habitat insert 86 are a soft, moisture absorbent material for purposes previously described.

Cricket habitat 80 includes a removable cover 94 secured in a first end of housing 82. Cover 94 is circular and frictionally fits in the open end of housing 82. Cover 94 includes a rim 96 that frictionally engages the interior walls of housing 82 at the end thereof. Rim 96 surrounds a cover base 98. Cover base 98 is a sight window formed of a transparent material such as a transparent plastic so as to permit viewing of crickets inside the housing 82 from the exterior thereof. Cover rim 96 and cover base 98 can be formed of a single piece of transparent material.

The second end of housing 82 is closed. It can be closed by a second friction-fit removable cover 102. Second cover 102 can be transparent or opaque. Alternatively the second end of housing 82 can be closed by a permanent closure means.

While certain embodiments of the invention have been shown and described herein, it will be apparent to those skilled in the art that deviations can be had from the embodiments shown without departing from the scope and spirit of the invention.

The embodiments of the invention in which an exclusive property or privilege is claimed are defined as follows:

1. An insect habitat and point of sale package comprising:
a housing having side walls that define an interior habitat space for insects;
a habitat insert located in the habitat space of the housing, said insert comprised as a multisided structure having convoluted surfaces partitioning the habitat space into discrete subspaces to accommodate insects residing in the habitat space;
a window in a wall of the housing, said window comprised of an opening cut out of a wall of the housing and a transparent material covering the opening; and
an item of insect food located in the habitat space.

2. The insect habitat of claim 1 wherein:
said housing is a rectangular box formed of a cardboard like material having a top wall and a front wall, said window formed in the top wall and front wall.

3. The insect habitat of claim 2 wherein:
said habitat insert is formed of an egg carton-type structure.

4. The insect habitat of claim 3 wherein:
said habitat insert is formed of a moisture absorbent material.

5. The insect habitat of claim 3 wherein:
said box has a top wall, bottom wall, and front and back walls, and at least one closeable open end;
closure means for closing the open end of the box including opposable end flaps, each of a size to cover the end opening, and top and bottom flaps foldable over the end flaps in covering relationship to the end opening, and means to secure the top and bottom flaps in place folded over the end flap.

6. The insect habitat of claim 3 wherein:
said habitat insert fits loosely in the housing permitting insects to move from one surface to another.

7. The insect habitat of claim 2 including:
a dispenser including an elongated dispenser carton having cross sectional dimensions to accommodate said housing;
said carton having a front wall and a dispenser opening in the front wall of a size to permit dispensing of the housing from the interior of the carton;
at least one housing located in the dispenser.

8. The insect habitat of claim 6 wherein:
said front wall of the dispenser carton has at least one sight opening.

9. The insect habitat of claim 7 including:
a plurality of housings stacked up in the interior of said dispenser carton.

10. The insect habitat of claim 1 wherein:
said housing is comprised as a cylindrical box having an open end;
a circular cover frictionally engaged with the open end of the box to close the open end;
said cover having said window.

11. The insect habitat of claim 10 wherein:
said cover is comprised of a transparent material.

12. A cricket habitat and point of sale package comprising:
a rectangular box-like housing having connected top and bottom walls and front and back walls and end closures defining an interior space for a habitat space for live crickets;
a habitat insert located in the interior space of the housing and formed of a two sided sheet material having moisture absorbing characteristics;
said sheet material having a convoluted surface forming a plurality of peaks and valleys partitioning the habitat space into discrete subspaces accessible to crickets in the housing;
a sight opening in at least one wall of the housing;
a transparent material covering the sight opening so that crickets inside of the housing can be seen from outside of the housing;
a piece of cricket food located inside the housing;
closure means for the end openings comprised as end flaps foldable over the end openings, and top and bottom flaps foldable over the end flaps.

13. The cricket habitat of claim 12 wherein:
said window in housing comprises a sight opening located in the top wall of the housing and a sight opening located in the front wall of the housing joining the sight opening in the top wall of the housing, and said transparent material covering the sight opening in the top wall of the housing and the sight opening in the front wall of the housing.

14. The cricket habitat of claim 12 wherein:
said box is made of cardboard.

15. The cricket habitat of claim 14 wherein:
said habitat insert is formed of an egg carton type structure.

16. The cricket habitat of claim 14 including:
a plurality of crickets located inside of the housing.
